(19) United States
(12) Patent Application Publication
(10) Pub. No.: US 2013/0017531 A1
(43) Pub. Date: Jan. 17, 2013

(54) TESTING SYSTEM AND METHOD USING AN IPSATIVE SCALE

(71) Applicant: Yao-Ting Sung, Taipei City (TW)

(72) Inventor: Yao-Ting Sung, Taipei City (TW)

(73) Assignee: NATIONAL TAIWAN NORMAL UNIVERSITY, Taipei City (TW)

(21) Appl. No.: 13/298,435

(22) Filed: Nov. 17, 2011

(30) Foreign Application Priority Data
Jul. 12, 2011 (TW) 100124546

(51) Int. Cl. G09B 7/00

(52) U.S. Cl. 434/362

(57) ABSTRACT

A testing system using an ipsative scale is applicable to a data processing device. The testing system includes a test question module for generating test questions comprising questions, a measuring scale and a plurality of labels, and a responding module for moving each of the labels to a corresponding position on the measuring scale in response and according to the question, and a recording module for recording information about the position of each label as a fall point, wherein the fall point information compares one or more test-takers for obtaining a correlation between the test questions of each label, thereby analyzing test results of one or more test-takers and reducing occurrence of faked test results.

### BACKGROUND OF THE INVENTION

1. Field of the Invention

The present invention relates to a testing system and method using an ipsative scale, and, more particularly, to a testing system and method capable of analyzing the extent to which respondents are affected by the contents of a test.

2. Description of Related Art

In order to obtain information about an individual's thoughts and innate traits, the conventional Likert-type scale is commonly used in survey research. Particularly, it is widely adopted in business and industrial recruitments and selections, thereby acquiring respondents' personality characteristics with test results. The Likert Scale is an ordered, one-dimensional scale from which respondents choose one option that best aligns with their view.

As shown in FIG. 5A, a schematic diagram shows a Likert questionnaire item for respondents to choose from a selected response of 1 to 6 points. In scoring, however, given that the test score may substantially affect the result of decision-making, for example, in a situation where a respondent may fail the test to be selected due to the low scores in certain items, such that they may not opt to submit true answers in order to gain advantages when facing keen competitions, thus rendering fake answers and failing to reflect respondents' real preferences and standing.

To counteract respondent faking, currently ipsative testing became a common test tool that is widely adopted for business purposes. FIG. 5B depicts a type of the ipsative questionnaire item for respondents to choose a specific and personal preference among the selectedn items. Compared to the foregoing self-stated type of measurement, the ipsative item force respondents to differentiate a preference in each selection item to summarize the scores accordingly, thereby reducing the probability of submitting faked answers since the importance and the order of each item has to be ascertained before a faked answer is submitted.

However, much has been written about the difficulties and limitations of using the ipsative measurement and forced-choice response styles in the assessment of personality using multi-scale questionnaires. One of the problems of ipsative testing is that the test result merely provides the result of respondents' priorities but it is impossible to compare and analyze or interpret the data using standardized procedures or that they can only be used in restricted contexts. Due to the strong interdependencies between different selection items, each respondent would eventually gain the same scaled score after computing but it is impossible to explain the extent to which it affects individuals in the same selection item. For instance, it merely shows that respondent A prefers watching movies to exhibitions but fails to explain the extent to which the respondent in favor of these activities, making valid comparisons of personal characteristics impossible.

Therefore, it is desirable and highly beneficial to discover a more ideal and satisfying testing system that can reflect the true personality traits, weaknesses and strengths of respondents to efficiently overcome the drawbacks of prior techniques.

### SUMMARY OF THE INVENTION

In view of the drawbacks associated with the prior techniques, a primary objective of the invention is to provide a testing system and method using an ipsative scale, which incorporate features of the Likert scale and the ispsative scale to generate test content that is assessable and suitable for the application of one or more respondents.

To achieve the aforementioned and other objectives, the invention provides a testing system using an ipsative scale, applied to a data processing apparatus that includes a processor, a memory, a storage unit and an operating system, and including a test question module for generating test questions comprising questions, a measuring scale and a plurality of labels, a responding module for moving the labels by dragging them to corresponding positions on the measuring scale in response and according to the questions, and a recording module for recording information on the positions corresponding to the labels as fall point information, wherein the fall point information compares one or more test-takers to obtain a correlation between the test questions of the labels, thereby analyzing test results of one or more test-takers and reducing faking test results.

In one embodiment, the fall point information comprises recording the coordinate information regarding the position of each of the labels on the measuring scale, and the sequence information on the order of the labels.

In one preferred embodiment, the testing system using an ipsative scale of the present invention further includes an analysis module for calculating the fall points of the labels in order to acquire an intensity value of each of the labels in the test questions.

In addition, the correlation mentioned above refers to the intensity value of each of the labels generated by the analysis module to obtain an intensity correlation of each of the labels with respect to one respondent, and an intensity relation of the same label among different respondents.

Further, the invention provides a testing method using an ipsative scale, the method including the steps of (1) generating test questions comprising questions, a measuring scale and a plurality of labels; (2) moving the labels to corresponding positions on the measuring scale in response and according to the questions; (3) recording information on the positions corresponding to the labels as fall point information, wherein the fall point information compares the scores of one or more test-takers to obtain a correlation between the test questions of each of the labels; and (4) analyzing the fall point information for comparing the correlation of each of the labels among one or more respondents.

Compared to prior techniques, the testing system and method of this invention is characterized by adopting an ipsative scale and the test questions generated therefrom incorporate the features of the ipsative and Likert scales to obtain test results with a relatively high reliability, thereby indicating the personality weaknesses and strengths of respondents and achieving characteristic comparisons among respondents.

Accordingly, the testing system and method using an ipsative scale of this invention has the advantages of obtaining assessable test results that can analyze the extent to which the respondents are affected by test content.

### BRIEF DESCRIPTION OF THE DRAWINGS

The present invention can be more fully understood by reading the following detailed description of the preferred embodiments, with reference made to the accompanying drawings, wherein:

FIG. 1 is a functional block diagram of an ipsative scale testing system in accordance with the present invention;

FIG. 2 is a schematic diagram showing a preferred embodiment of a measuring scale with labels in accordance with the present invention;

FIG. 3 is a flowchart showing the steps of the testing method using an ipsative scale in accordance with the present invention;

FIGS. 4A to 4C are schematic diagrams showing records of the test questions and answers generated by the ipsative scale testing system in accordance with the present invention;

FIG. 5A is a schematic diagram showing the questionnaires using the Likert and ipsative scales in accordance with the present invention; and

FIGS. 5B to 5C are schematic diagrams showing the questionnaires using the ipsative scale in accordance with the present invention.

### DETAILED DESCRIPTION OF THE PREFERRED EMBODIMENTS

The following illustrative embodiments are provided to illustrate the disclosure of the present invention, these and other advantages and effects can be understood by persons skilled in the art after reading the disclosure of this specification. Note that the structures, proportions, sizes depicted in the accompanying figures merely illustrate the disclosure of the specification to allow for comprehensive reading without a limitation to the implementation or applications of the present invention, and does not constitute any substantial technical meaning.

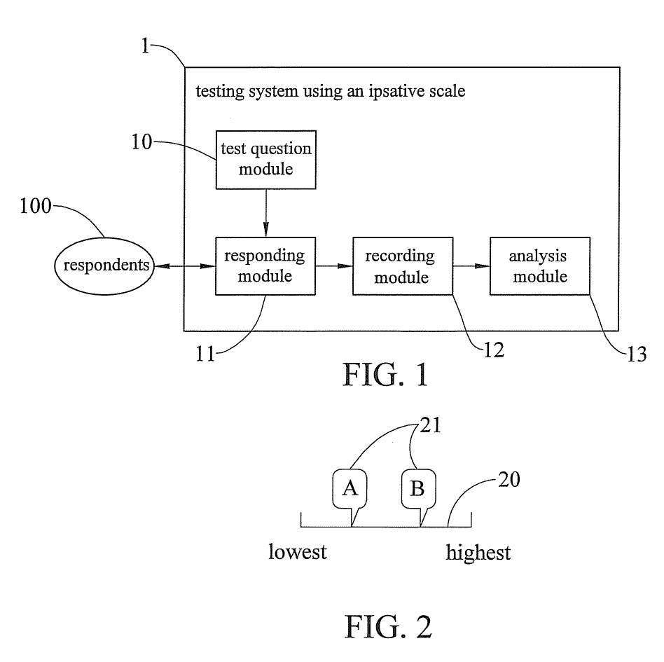

FIG. 1 is a functional block diagram of the testing system using an ipsative scale in accordance with the present invention. As illustrated, the testing system 1 using an ipsative scale combines the features of a self-stated scale and an ispative scale, and comprises a test question module 10, a responding module 11, a recording module 12, and an analysis module 13. Note that the testing system 1 using an ipsative scale is applicable to data processing equipment of computers, which may includes a processor, a memory and an operating system, for purposes of survey research to provide workplace tests, orientation tests, interest tests, personality tests or marketing research and survey. And, testing system 1 using an ipsative scale is characterized by its unique testing methods and results and its applications should not be restricted.

The test question module 10 is used for generating test questions comprising test questions, a measuring scale and a plurality of labels posited on the measuring scale. Specifically, the test question module 10 generates test questions for respondents 100 to response thereto, and is different from the conventional self-stated scale that merely allows respondents to fill in each given option with a score, or different from the conventional ipsative scale test type with forced pair options to choose therebetween. The test questions generated by the test question module 10 comprise test questions, a measuring scale and a plurality of labels posited on the measuring scale, which may be displayed on a monitor. In an embodiment, the test questions refer to the content of questions, and the measuring scale is a continuous axle without the scale mark, such that any point on the measuring scale can be recorded as a fall point, wherein each of the two ends on the scale represent the highest and the lowest scores, extents or intentions, and each label corresponds to a descriptive option for allowing the respondents 100 to response thereto via labels with a control device, such as a keyboard, mouse, or touch-pad.

The responding module 11 is adapted for allowing each of the labels to move by respondents 100 to a corresponding position on the measuring scale in response and according to the question. As indicated above, the test question module 10 comprises test questions, a measuring scale and a plurality of labels posited on the measuring scale, which may be displayed on the monitor, and the respondents 100 can move labels, by using the control device, to respective positions on the scale according to the content of the question, by dragging each label to an appropriate position on the measuring scale as required.

The recording module 12 records information on the position of each label on the measuring scale as a fall point, wherein the fall point information is used to compare the correlation between each of the labels and one or more respondents with respect to the test questions. When respondents 100 move each label to an appropriate position, the recording module 12 then records information on the position of the labels on the measuring scale, which are referred to as the fall point information to be used by the analysis module 13 in the subsequent data analysis, to obtain the respondents' 100 selection difference. The recording module 12 may be connected to a harddisk and a storage unit of a data processing apparatus or to a storage device, to store the fall point information. The fall point information comprises the coordinate data of each label placed on a specific position on the measuring scale and the sequential order of labels, wherein the coordinate data refers to records of positions of each label on the measuring scale for the use of the subsequent intensity comparison analysis, and the sequence data refers to the order of each label which is used to analyze the extent to which respondents 100 are affected. Therefore, the fall point information about each label can be used for the following analysis, such as the correlation between each of the labels or one or more respondents.

The aforementioned correlation refers to an intensity value of each label, which is obtained after the value of intensity with respect to one respondent is analyzed and calculated, which means the degree of influence to one respondent in the options, which can also be analyzed and calculated to obtain the correlation of the same label between one or more respondents, that is, the extent and influence about a certain choice among different respondents.

In other words, the coordinate data refers to records of positions of labels on the measuring scale, as stated above, the measuring scale includes a continuous axle without the scale mark that allows respondents 100 to drag and place the labels at any random positions thereon as wished, and the recording module 12 records the position of the label using pixels as a unit. In an embodiment, the left end is a point of Opx, and the label is drawn to a certain position of the measuring scale, a corresponding pixel may be recorded as a fall point, for example, 200 px. The foregoing instance is merely illustrative of a method to record related fall point information and not restrictive in any sense. For example, the measuring scale can be a continuous axle with a hidden scale mark for the purpose of recording, so long as the position of the label on the measuring scale can be recorded, including the foregoing method of using pixels as a unit.

Moreover, in order to prevent more than one labels from being overlapped or placed too close together, the responding module 11 judges the position between labels to avoid any incidence that is unrecognizable, and the overlapping may be further defined as required, such as a distance of 10 px is almost visually unrecognizable, so that if there is a label which is placed at a position of 281 px, any of the other labels then cannot be placed at the position of 271 px-291 px as a fall point. Incidentally, the responding module 11 would provide some warning messages in the form such as a dialogue window to inform respondents 100 of an alternative answer, thereby preventing respondents 100 from placing or moving more than one labels to an identical or similar position that would otherwise cause hindrance to the selection and assessment of intensity values.

Next, FIG. 2 shows a preferred embodiment of a measuring scale and labels to be placed thereupon according to the present invention. As illustrated, the ipsative scale testing system is displayed on the monitor, and respondents may watch the monitor to know that the measuring scale 20 has a plurality of labels 21 placed thereupon, wherein the measuring scale 20 is a continuous axle without the scale mark that prevents respondents from creating any specific distance between labels 21, each of which corresponds to one of the question items in the test questions for allowing respondents to move each of these labels 21 to a proper position on the measuring scale 20 and thus complete the test accordingly.

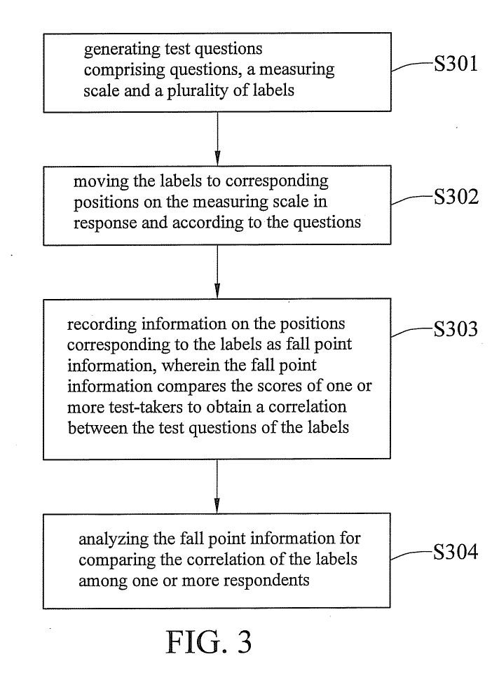

In conjunction with the testing system using an ipsative scale as illustrated in FIGS. 1 and 2, FIG. 3 details the steps of the testing method of using an ipsative scale as follows.

In step S301, a plurality of test questions each comprised of questions, a measuring scale and a plurality of labels to be placed on the measuring scale are generated for allowing respondents to read the test by watching the monitor and take the test according to test questions by manipulating the operable measuring scale and labels to correspond to respondents' desirable options. Subsequently, the method proceeds to step S302.

In step S302, each of the labels is moved to a corresponding position of the measuring scale. Specifically, respondents 100 may use the mouse, the keyboard or the touch-pad to drag or click these labels on the measuring scale, and often the left end of the measuring scale is designed to indicate a lowest degree of intention or desirability while the right end thereof indicates a highest degree of intention as a reference point for respondents to move each of these labels to a proper position on the scale as required. In addition, the step S302 further includes generating a warning message so that each label can be placed within a certain distance from one another, and respondents 100 are thus prevented from moving all or more than one labels to the same position that would make the sequential order or the degree of intensity unrecognizable as a result. Therefore, when a label is moved away from another label out of a certain distance, a warning message will be issued for respondents to correct such. The warning message may come in the form of a dialogue frame, a sound or a compulsory step-back to a previous step, and so on. Also, step S302 does not allow for any overlap of the position of labels on the scale. Subsequently, the method proceeds to step S303.

In step S303, the position of each label on the measuring scale is recorded as fall point information for the subsequent comparison and assessment. The fall point information may be stored in a storage unit of a data processing apparatus, or stored in an external storage device connected to the data processing apparatus. The fall point information comprises the coordinate data of each label on the measuring scale, and data of the sequential order of each label being placed upon. Although the measuring scale in the testing process is a continuous axle without the scale mark, the position of labels can be recorded as the coordinate data by means of pixel units, as well as the order of the displayed labels for later use. Then, the method proceeds to step S304.

In step S304, the fall point information is analyzed to compare the correlation between each of the labels and one or more respondents with respect to test questions. Specifically, the fall point information on each label can be analyzed by the data processing device to obtain optional differences among respondents, wherein any fall point information can be calculated to obtain an intensity value of the labels, and lastly, the intensity value of each label is used for the influence assessment.

In addition, step S304 further includes an intensity value of each label for performing the subsequent analysis of the effect of descriptive options have on respondents, that is, the foregoing correlation obtained from the intensity analysis, which can be used to compare the intensity value of one respondent with regard to each option to obtain an intensity relation of each label, or can be used to compare the intensity value of more than one respondents to obtain an intensity relation of each label among different respondents. As such, the testing method using an ipsative scale of the invention provides outstanding advantages and noticeable improvements over the prior art because it is capable of analyzing different effects and intensity values of one or more respondents to descriptive options represented by each label on the scale.

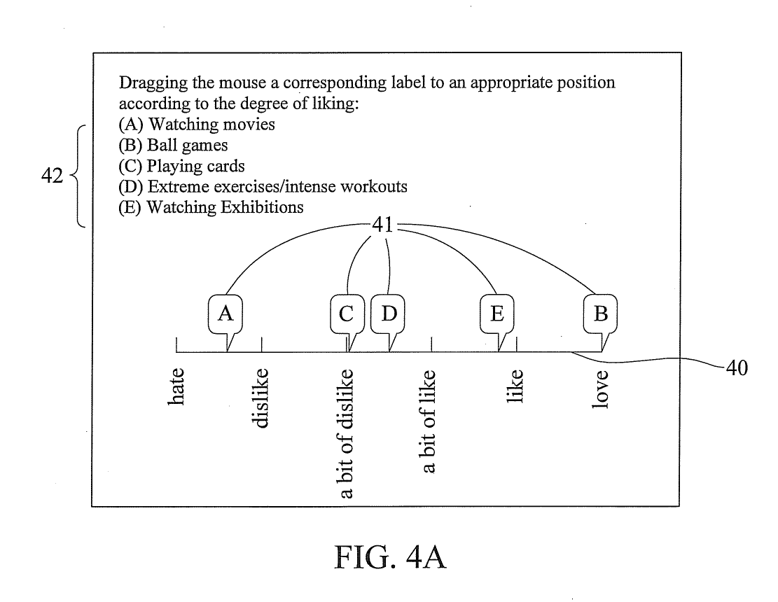

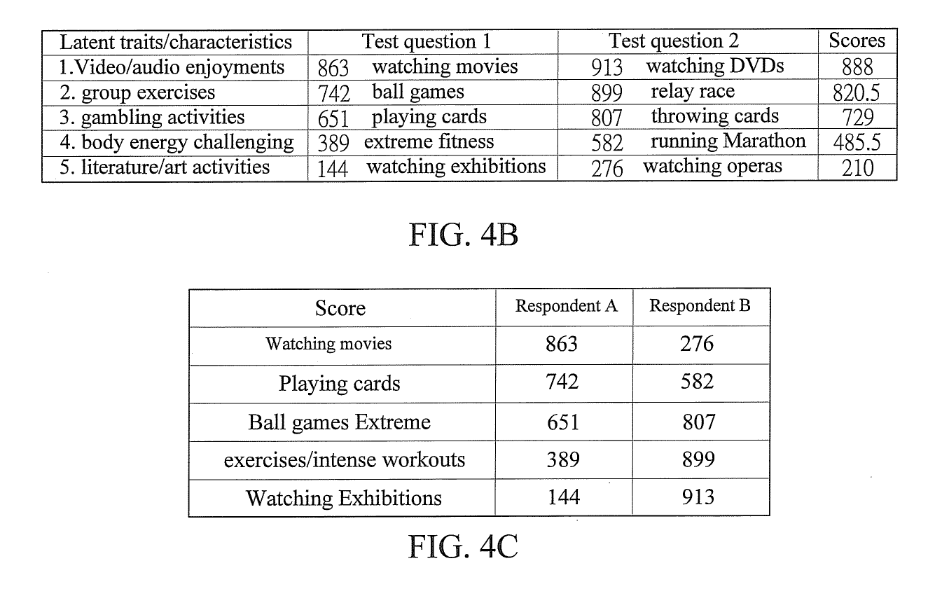

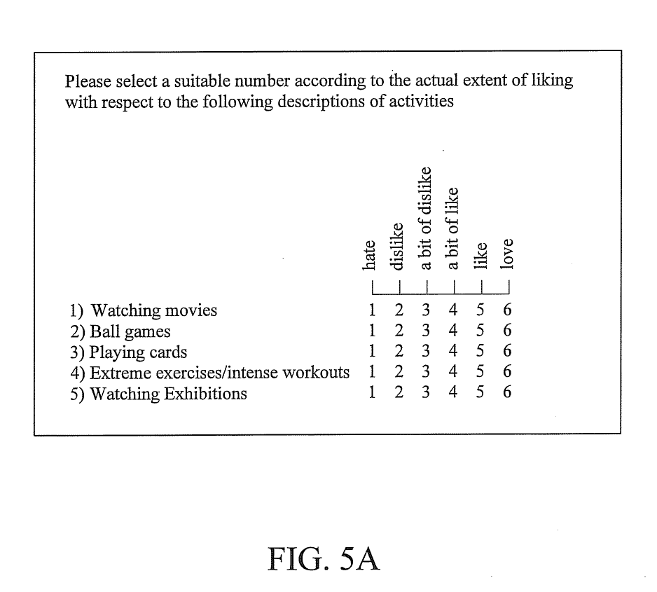

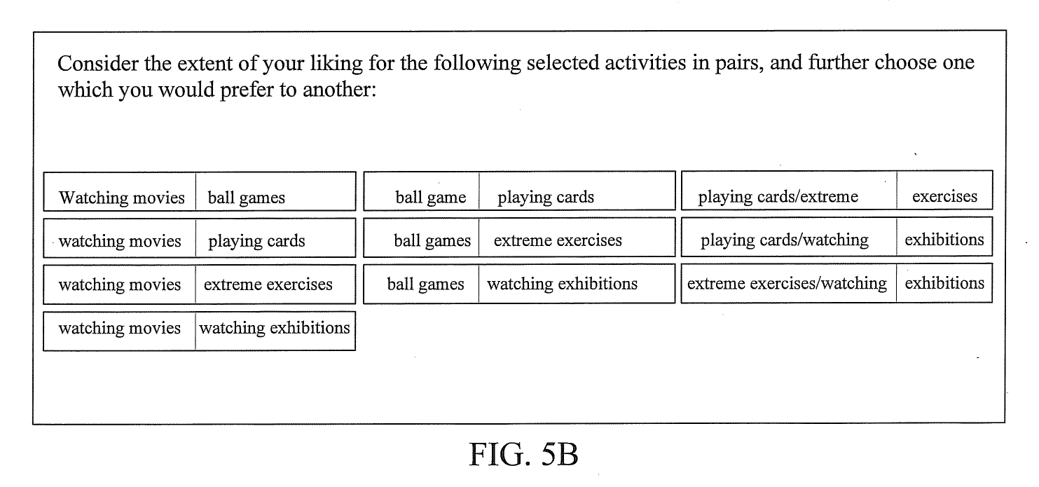

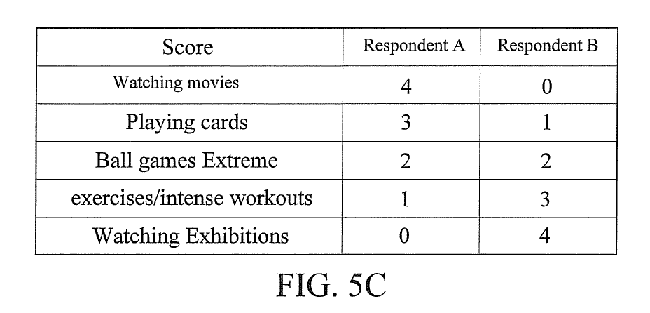

FIGS. 4A-4C are schematic diagrams of the test questions and answers generated by the testing system using an ipsative scale of the invention. In FIG. 4A, a typical test question shown on the monitor of the data processing device for respondents to choose the degree/intensity of liking from among five descriptive options 42 is depicted, each descriptive option 42 corresponding to one of the labels 41 on the ipsative scale, wherein respondents may use a control device, such as a mouse or a keyboard, to drag each of these labels 41 to a chosen position on the ipsative scale 40, so as to record related information about each label 41 in the storage unit of the data processing device for performing the subsequent assessment and calculation by using the data processing device. This allows information on respondents' specific degrees of intensities of liking to descriptive options 42 to be analyzed, and further to be compared in one or among different respondents, thereby effectively preventing and reducing faked test results due to respondents' concerns of not being chosen as encountered in prior techniques, or failures to analyze varying intensities among respondents in favor of the same options.

FIG. 4B shows respondents' answers to test question 1 and test question 2, which comprise different test questions 1 and 2 designed for five types of A to E of latent characteristics and generate different contents of options. After the test, the system records the test results of respondents' answers and calculates each of the characteristic scores. For example, the respondent's answer about watching movies in test question 1 is recorded as 863 px, and the answer about watching DVDs in test question 2 is recorded as 913 px, and since both labels indicate a similar tendency and share the common latent characteristics (watching movies/videos) to obtain a mean score of 888 as the latent characteristics A, thereby demonstrating degrees of liking intensities in one or among different respondents with respect to a variety of latent characteristics.

In FIG. 4B, two respondents' answers to the test question are recorded, in which ball games ranked the third high degree of liking for the two respondents A and B, although respondent B has a higher score 807 px than respondent A scored at 651 px, which indicates that respondent B has a higher preference for ball games than respondent A, thereby using the measured scores for comparison among respondents while explaining the difference of intensities therebetween.

Summarizing the above, the invention is characterized in combining features of the self-report measurement with the ipsative scale measurement, which requires only respondents to move by dragging the position of labels on the measuring scale to respective chosen options, so that respondents may decide the order of each option rather than the conventional forced choice pairs that tend to induce faked test results. At the same time, the coordinates position of the given options also provide for the subsequent comparison with degrees of intensities in one or more respondents with respect to a variety of latent characteristics.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A testing system using an ipsative scale, applied to a data processing apparatus that includes a processor, a memory, a storage unit and an operating system, the testing system comprising:
a test question module for generating test questions comprising questions, a measuring scale and a plurality of labels;
a responding module for moving the labels to corresponding positions on the measuring scale in response and according to the test questions; and
a recording module for recording information on the positions corresponding to the labels as fall point information, wherein the fall point information compares one or more test-takers to obtain a correlation between the test questions of each of the labels, thereby analyzing test results of one or more test-takers and reducing faking test results.

2. The testing system of claim 1, wherein the test questions comprise multiple descriptive options, and each of the labels corresponds to respective descriptive options.

3. The testing system of claim 1, wherein the measuring scale is a continuous axle without a scale mark, and the recording module records information on the positions of labels as fall points using pixels as a unit.

4. The testing system of claim 1, wherein the fall point information comprises coordinate data of each of the labels placed on a specific position on the scale and the sequential order of the labels.

5. The testing system of claim 1, further comprising an analysis module for calculating the fall point information of any of the labels, thereby obtaining an intensity value of the labels with respect to the test questions.

6. The testing system of claim 5, wherein the correlation refers to an intensity relationship generated by the analysis module according to an intensity value of each of the labels of one respondent and the same label among more respondents.

7. The testing system of claim 1, wherein the responding module provides a warning message within a predetermined distance of the positions of the labels, such that the labels are prevented from being overlapped with one another on a corresponding position of the measuring scale.

8. A testing method using an ipsative scale, comprising the steps of:
(1) generating test questions comprising questions, a measuring scale and a plurality of labels;
(2) moving the labels to corresponding positions on the measuring scale in response and according to the test questions;
(3) recording information on the positions corresponding to the labels as fall point information, wherein the fall point information compares scores of one or more test-takers to obtain a correlation between the test questions of each of the labels; and
(4) analyzing the fall point information for comparing the correlation of each of the labels among one or more respondents.

9. The testing method of claim 8, wherein wherein fall point information comprises the coordinate data of each of the labels placed on a specific position on the scale and the sequential order of the labels.

10. The testing method of claim 9, wherein the measuring scale is a continuous axle without a scale mark, and the coordinate information denotes the positions of the labels using pixels as a unit.

11. The testing method of claim 8, wherein step (4) further comprises calculating the fall point information about any of the labels to obtain an intensity value of the labels with respect to the test questions.

12. The testing method of claim 11, wherein the correlation refers to an intensity relationship generated by the analysis module according to the intensity value of each of the labels of one respondent and the same label among more respondents.

13. The testing method of claim 8, wherein step (2) further comprises providing a warning message within a predetermined distance of the positions of the labels, such that the labels are prevented from being overlapped with one another on a corresponding position of the measuring scale.
